(19) United States
(12) Patent Application Publication
(10) Pub. No.: US 2026/0351826 A1
(43) Pub. Date: Nov. 5, 2026

(54) DIGITAL PHASE-SHIFT CIRCUIT AND DIGITAL PHASE SHIFTER

(71) Applicant: Fujikura Ltd., Tokyo (JP)

(72) Inventor: Yusuke Uemichi, Sakura-shi (JP)

(73) Assignee: Fujikura Ltd., Tokyo (JP)

(21) Appl. No.: 19/485,840

(22) PCT Filed: May 15, 2024
(86) PCT No.: PCT/JP2024/017967

§ 371 Date: Nov. 19, 2025

(30) Foreign Application Priority Data
Jun. 7, 2023 (JP) 2023-093907

(51) Int. Cl. H01P 1/18; H01P 1/12

(52) U.S. Cl. CPC H01P 1/184; H01P 1/127

(57) ABSTRACT

A digital phase-shift circuit includes a signal line, a first line including a first parallel line, a second line including a second parallel line, a third line including a first intersecting line, a third parallel line, and a second intersecting line, a first ground conductor, a second ground conductor, a first electronic switch, and a second electronic switch, in which the signal line is located between the first parallel line and the second parallel line, and a cross-sectional area of the third line is smaller than cross-sectional areas of the signal line, the first line, and the second line.

### TECHNICAL FIELD

The present invention relates to a digital phase-shift circuit and a digital phase shifter.

Priority is claimed on Japanese Patent Application No. 2023-093907, filed Jun. 7, 2023, the content of which is incorporated herein by reference.

### BACKGROUND ART

Non Patent Document 1 discloses a digital control type phase-shift circuit (digital phase-shift circuit) for microwaves, quasi-millimeter waves, or millimeter waves, The digital phase-shift circuit includes, as shown in FIG. 2 of Non Patent Document 1, a signal line, a pair of inner lines, a pair of outer lines, a first ground bar, a second ground bar, a pair of NMOS switches, and the like. The pair of inner lines are provided on both sides of the signal line. The pair of outer lines are provided outside the pair of inner lines. The first ground bar is connected to a first end of each of the inner lines and a first end of each of the outer lines. The second ground bar is connected to a second end of each of the outer lines. Each of the NMOS switches is provided between a second end of each of the inner lines and the second ground bar.

In such a digital phase-shift circuit, an operation mode is switched between a low-delay mode and a high-delay mode by switching a return current flowing through the pair of inner lines or the pair of outer lines in response to the transmission of the signal waves in the signal line, in accordance with opening/closing of the pair of NMOS switches. That is, in the digital phase-shift circuit, the operation mode is the low-delay mode in a case where the return current flows through the pair of inner lines, and the operation mode is the high-delay mode in a case where the return current flows through the pair of outer lines.

### CITATION LIST

### Non Patent Document

Non Patent Document 1: A Ka-band Digitally-Controlled Phase Shifter with sub-degree Phase Precision (2016, IEEE, RFIC)

### SUMMARY OF INVENTION

### Technical Problem

In the digital phase-shift circuit, in order to ensure a phase-shift amount in a limited area, it is desirable that, for the inductance that is one of the circuit constants, a value (inductance value) in the high-delay mode be sufficiently larger than an inductance value in the low-delay mode. However, in the above-described digital phase-shift circuit in the related art, in order to increase the inductance value in the high-delay mode, it is necessary to separate the outer lines from the signal line (or to increase the length of the outer lines), and thus the size increases. Since the digital phase shifter has a configuration in which a plurality of digital phase-shift circuits are cascade-connected, the digital phase shifter is increased in size in a case where the size of the digital phase-shift circuit is increased.

The present invention has been made in view of the above-described circumstances, and an object of the present invention is to provide a digital phase-shift circuit and a digital phase shifter that can achieve desired phase-shift characteristics with a small size compared to the related art.

### Solution to Problem

A digital phase-shift circuit (B, B′, B″) according to a first aspect of the present invention includes a signal line (10), a first line (21) including a first parallel line (21p1) extending parallel to the signal line, a second line (22) including a second parallel line (22p2) extending parallel to the signal line, a third line (23) including a first intersecting line (23c1) connected to a first end portion of the second parallel line and extending away from the signal line in an intersection direction (Y) intersecting a longitudinal direction of the signal line from the first end portion of the second parallel line in plan view, a third parallel line (23p3) extending parallel to the signal line from a first end portion of the first intersecting line, and a second intersecting line (23c2) extending toward the signal line in the intersection direction from a first end portion of the third parallel line, a first ground conductor (31) electrically connected to a first end portion of the first parallel line and the first end portion of the second parallel line, a second ground conductor (32) electrically connected to a first end portion of the third line, a first electronic switch (41) provided between a second end portion of the first parallel line and the second ground conductor, and a second electronic switch (42) provided between a second end portion of the second parallel line and the second ground conductor, in which the signal line is located between the first parallel line and the second parallel line, and a cross-sectional area of the third line is smaller than cross-sectional areas of the signal line, the first line, and the second line.

In the digital phase-shift circuit according to the first aspect of the present invention, in a low-delay mode in which the first electronic switch and the second electronic switch are set to a closed state, a first return current flows through the first parallel line that forms a part of the first line, and a second return current flows through the second parallel line that forms a part of the second line. On the other hand, in a high-delay mode in which the first electronic switch and the second electronic switch are set to an off state, a third return current flows through the third line (the second intersecting line, the third parallel line, and the first intersecting line) having the cross-sectional area smaller than the cross-sectional areas of the signal line, the second line, and the second line. As a result, the inductance value can be increased, and thus desired phase-shift characteristics can be achieved with a small size compared to the related art.

According to a second aspect of the present invention, in the digital phase-shift circuit according to the first aspect of the present invention, the third line has a smaller thickness than the signal line, the first line, and the second line.

According to a third aspect of the present invention, in the digital phase-shift circuit according to the first or second aspect of the present invention, the third line is formed in an inner layer than the first line and the second line.

According to a fourth aspect of the present invention, in the digital phase-shift circuit according to any one of the first to third aspects of the present invention, a plurality of holes (H) are formed along the third line in the third line.

According to a fifth aspect of the present invention, the digital phase-shift circuit according to any one of the first to fourth aspects of the present invention further includes a capacitor (60) connected to a first end portion of the signal line, and a third electronic switch (43) provided between the capacitor and the first ground conductor, in which a first end portion of the first ground conductor extends away from the signal line in the intersection direction and is connected to the third electronic switch.

According to a sixth aspect of the present invention, in the digital phase-shift circuit according to the fifth aspect of the present invention, the first electronic switch, the second electronic switch, and the third electronic switch are field-effect transistors, and sizes of the field-effect transistors forming the first electronic switch and the second electronic switch are at least twice a size of the field-effect transistor forming the third electronic switch.

According to a seventh aspect of the present invention, the digital phase-shift circuit according to any one of the first to sixth aspects of the present invention further includes a first upper pad (21d2) provided at the second end portion of the first parallel line, and a second upper pad (22d2) provided at the second end portion of the second parallel line, in which a maximum value of a dimension of the first upper pad in the intersection direction is larger than a width of the first parallel line, and a maximum value of a dimension of the second upper pad in the intersection direction is larger than a width of the second parallel line.

According to an eighth aspect of the present invention, the digital phase-shift circuit according to the seventh aspect of the present invention further includes a first lower pad (33a) connected to the first upper pad through a via (50) and to which the first electronic switch is connected, and a second lower pad (33b) connected to the second upper pad through a via (50) and to which the second electronic switch is connected, in which a maximum value of a dimension of the first lower pad in the intersection direction is larger than the maximum value of the dimension of the first upper pad in the intersection direction, and a maximum value of a dimension of the second lower pad in the intersection direction is larger than the maximum value of the dimension of the second upper pad in the intersection direction.

According to a ninth aspect of the present invention, the digital phase-shift circuit according to any one of the first to eighth aspects of the present invention further includes a fourth electronic switch (44) provided between a first end portion of the signal line and the first ground conductor.

A digital phase shifter (A1 to A4) according to a first aspect of the present invention includes a plurality of digital phase-shift circuits (B₁ to Bₙ) that are cascade-connected, in which each of the plurality of digital phase-shift circuits is the digital phase-shift circuit according to any one of the first to ninth aspects, in a portion in which the digital phase-shift circuits are adjacent to each other, the first ground conductor and the second ground conductor are used in common, and the first intersecting line and the second intersecting line have a crank shape.

According to a second aspect of the present invention, in the digital phase shifter according to the first aspect of the present invention, at least one digital phase-shift circuit among the plurality of digital phase-shift circuits differs from the other digital phase-shift circuit in a distance (D1) between a center line of the second parallel line and a center line of the third parallel line in the intersection direction.

A digital phase shifter according to a third aspect of the present invention includes a plurality of digital phase-shift circuits (B₁ to Bₙ) that are cascade-connected, in which specific digital phase-shift circuits that are at least two digital phase-shift circuits among the plurality of digital phase-shift circuits are the digital phase-shift circuits according to the fourth aspect, in a portion in which the digital phase-shift circuits are adjacent to each other, the first ground conductor and the second ground conductor are used in common, and the first intersecting line and the second intersecting line have a crank shape.

According to a fourth aspect of the present invention, in the digital phase shifter according to the first aspect of the present invention, the third lines of the plurality of IS digital phase-shift circuits are formed in the same layer.

According to a fifth aspect of the present invention, in the digital phase shifter according to the first aspect of the present invention, the third line of at least one digital phase-shift circuit among the plurality of digital phase-shift circuits is formed in a different layer from the third line of the other digital phase-shift circuit.

### Advantageous Effects of Invention

According to the above-described aspects of the present invention, it is possible to achieve desired phase-shift characteristics with a small size compared to the related art.

### BRIEF DESCRIPTION OF DRAWINGS

FIG. 1 A plan view showing a basic configuration of a digital phase-shift circuit according to a first embodiment of the present invention.

FIG. 2 A cross-sectional view taken along line II-II in FIG. 1,

FIG. 3 A cross-sectional view taken along line II-III in FIG. 1.

FIG. 4 A plan view showing a connection relationship between connection pads and first and second electronic switches in the digital phase-shift circuit according to the first embodiment of the present invention.

FIG. 5 A plan view showing a configuration of main parts of a digital phase shifter according to the first embodiment of the present invention.

FIG. 6 A plan view showing a basic configuration of a digital phase-shift circuit according to a second embodiment of the present invention.

FIG. 7 A plan view showing a configuration of main parts of a digital phase shifter according to the second embodiment of the present invention.

FIG. 8 A plan view showing a basic configuration of a digital phase-shift circuit according to a third embodiment of the present invention.

FIG. 9 A plan view showing a configuration of main parts of a digital phase shifter according to a fourth embodiment of the present invention.

### DESCRIPTION OF EMBODIMENTS

Hereinafter, a digital phase-shift circuit and a digital phase shifter according to an embodiment of the present invention will be described in detail with reference to the accompanying drawings.

### First Embodiment

### <Digital Phase-Shift Circuit>

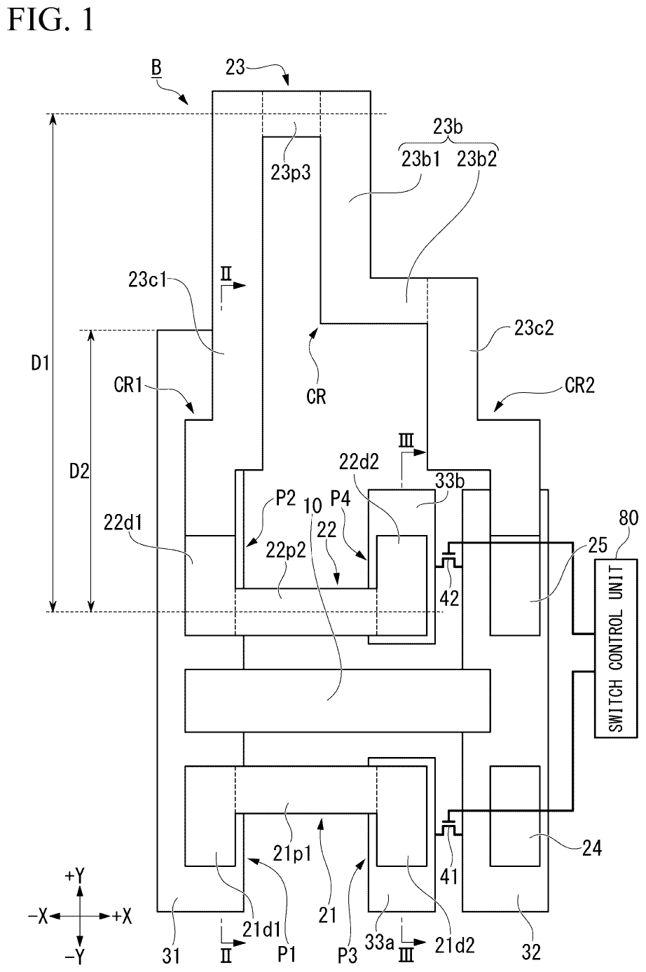

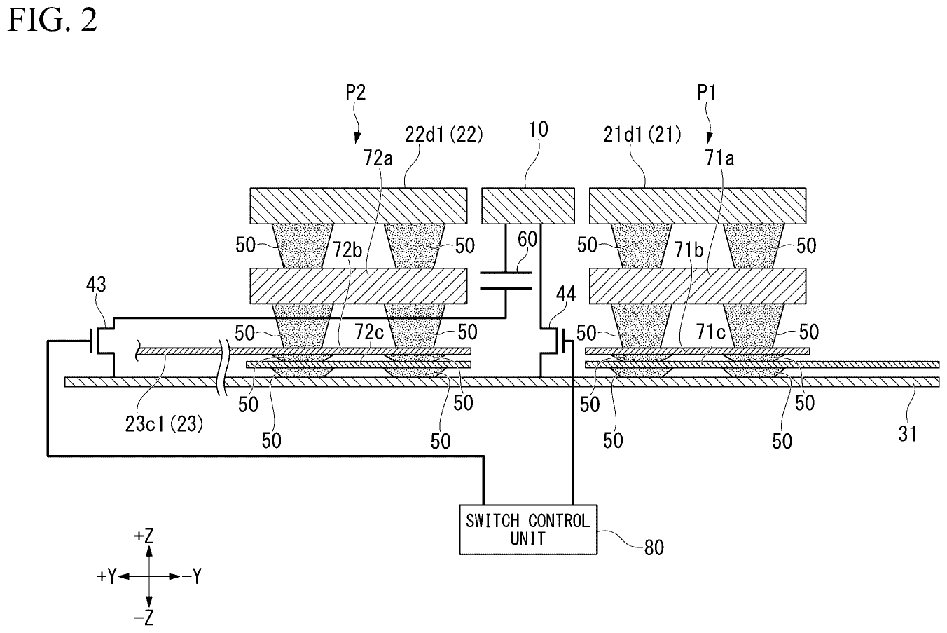

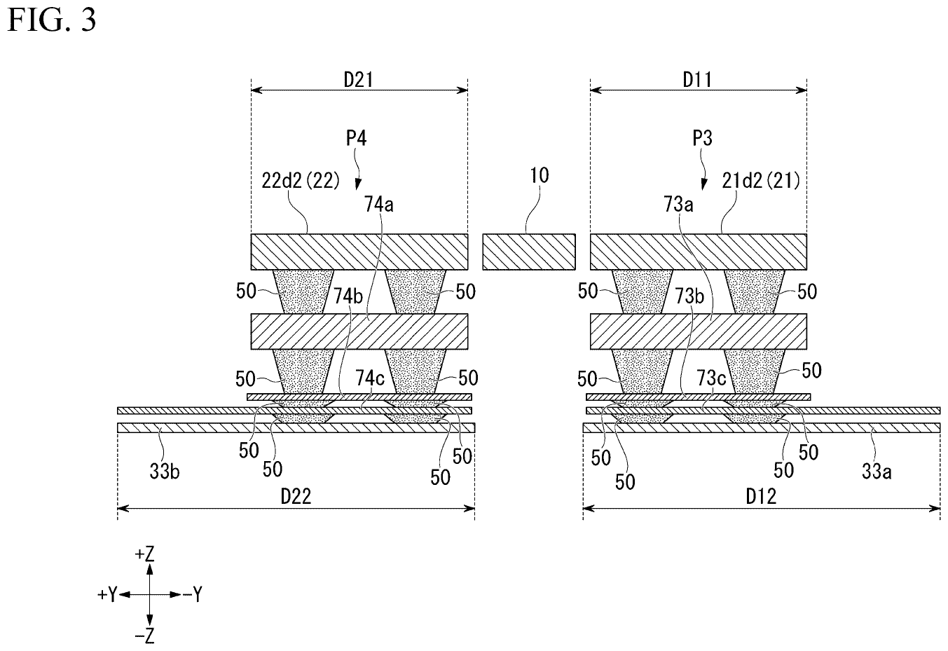

FIG. 1 is a plan view showing a basic configuration of a digital phase-shift circuit according to a first embodiment of the present invention. FIG. 2 is a cross-sectional view taken along line II-II in FIG. 1. FIG. 3 is a cross-sectional view taken along line III-III in FIG. 1.

As shown in FIG. 1, a digital phase-shift circuit B includes a signal line 10, a first line 21, a second line 22, a third line 23, an upper pad 24, an upper pad 25, a first ground conductor 31, and a second ground conductor 32. The first line 21 of the present embodiment includes a first parallel line 21p1 and a pair of upper pads 21d1 and 21d2. The second line 22 of the present embodiment includes a second parallel line 22p2 and a pair of upper pads 22d1 and 22d2. The third line 23 of the present embodiment includes a first intersecting line 23c1, a third parallel line 23p3, a bent line 23b, and a second intersecting line 23c2. In addition, the digital phase-shift circuit B of the present embodiment includes first to fourth electronic switches 41 to 44, a plurality of connection conductors 50, a capacitor 60, and a plurality of connection pads P1 to P4 (see also FIGS. 2 and 3).

As shown in FIG. 1, the signal line 10 is a linear strip-shaped conductor extending in one direction. That is, the signal line 10 is an elongated plate-shaped conductor having a constant width, a constant thickness, and a predetermined length. In the signal line 10, a signal current flows from a left side of a paper surface to a right side of the paper surface in FIG. 1, that is, from a left-side end portion (input end) of the paper surface to a right-side end portion (output end) of the paper surface. This signal current is a high frequency signal having a wavelength range of the microwaves, the quasi-millimeter waves, or the millimeter waves described above.

Here, in the present embodiment, a longitudinal direction of the signal line 10 (direction in which the signal line 10 extends) is simply referred to as a longitudinal direction X. A direction from the input end to the output end of the signal line 10 along the longitudinal direction X is referred to as a +X direction or a right side. A direction opposite to the right side is referred to as a left side or a −X direction. A direction intersecting (for example, being orthogonal to) the signal line 10 is referred to as an intersection direction Y. One direction along the intersection direction Y is referred to as a rear side or a +Y direction. A direction opposite to the rear side is referred to as a front side or a −Y direction. A direction intersecting (for example, orthogonal to) both the longitudinal direction X and the intersection direction Y is referred to as an up-down direction Z. One direction along the up-down direction Z is referred to as an upper side or a +Z direction. A direction opposite to the upper side is referred to as a lower side or a −Z direction. A view in the up down direction Z is referred to as plan view.

The up-down direction Z need not coincide with a vertical direction. Further, the “upper side” and the “lower side” need not coincide with an upper side and a lower side in the vertical direction. Further, the +X direction and the −X direction may be defined as a left side and a right side instead of defining the +X direction and the −X direction as a right side and a left side.

The signal line 10 has, electrically, an inductance L1 as a lumped-constant circuit element. The inductance L1 is a parasitic inductance having a magnitude corresponding to the shape of the signal line 10, such as the length of the signal line 10. In addition, the signal line 10 also has, electrically, a capacitance C1 as a lumped-constant circuit element. The capacitance C1 is a parasitic capacitance between the signal line 10 and the first parallel line 21p1 (described later in detail), between the signal line 10 and the second parallel line 22p2 (described later in detail), between the signal line 10 and the third parallel line 22p3 (described later in detail), between the signal line 10 and a silicon substrate (not shown), and the like.

In the following description, one side (+Y side) of the signal line 10 in the intersection direction Y is referred to as a first side of the signal line 10, and the other side (−Y side) of the signal line 10 in the intersection direction Y is referred to as a second side of the signal line 10. The first parallel line 21p1 is a linear strip-shaped conductor provided on the second side (−Y side) of the signal line 10. The first parallel line 21p1 is an elongated plate-shaped conductor having a constant width, a constant thickness, and a predetermined length. The first parallel line 21p1 extends parallel to the signal line 10 (in the longitudinal direction X). The first parallel line 21p1 and the signal line 10 are disposed with a spacing therebetween in the intersection direction Y. Among ends of the first parallel line 21p1, an end located on the −X side is referred to as a first end (one end), and an end located on the +X side is referred to as a second end (the other end). Among side edges of the first parallel line 21p1, a side edge located on the +Y side is referred to as a first side edge (one side edge), and a side edge located on the −Y side is referred to as a second side edge (the other side edge).

The upper pad 21d1 is a rectangular flat plate conductor that is connected to the first end (−X side) of the first parallel line 21p1. Long sides of the upper pad 21d1 extend in the intersection direction Y, and short sides of the upper pad 21d1 extend in the longitudinal direction X. Among the short sides of the upper pad 21d1, a short side located on the +Y side is referred to as a first short side (one short side), and a short side located on the −Y side is referred to as a second short side (the other short side). The first short side (+Y side) of the upper pad 21d1 is located at substantially the same position as the first side edge (+Y side) of the first parallel line 21p1 in the intersection direction Y. Further, the second short side (−Y side) of the upper pad 21d1 is located on the front side (−Y side) with respect to the second side edge (−Y side) of the first parallel line 21p1. That is, a dimension of the upper pad 21d1 in the intersection direction Y is larger than a width (dimension in the intersection direction Y) of the first parallel line 21p1.

The upper pad 21d2 (first upper pad) is a rectangular flat plate conductor that is connected to the second end (+X side) of the first parallel line 21p1. Long sides of the upper pad 21d2 extend in the intersection direction Y, and short sides of the upper pad 21d2 extend in the longitudinal direction X. Among the short sides of the upper pad 21d2, a short side located on the +Y side is referred to as a first short side (one short side), and a short side located on the −Y side is referred to as a second short side (the other short side). The first short side (+Y side) of the upper pad 21d2 is located at substantially the same position as the first side edge (+Y side) of the first parallel line 21p1 in the intersection direction Y. Further, the second short side (−Y side) of the upper pad 21d2 is located on the front side (−Y side) with respect to the second side edge (−Y side) of the first parallel line 21p1. That is, a dimension of the upper pad 21d2 in the intersection direction Y is larger than the width (dimension in the intersection direction Y) of the first parallel line 21p1.

The second parallel line 22p2 is a linear strip-shaped conductor provided on the first side (+Y side) of the signal line 10. The second parallel line 22p2 is an elongated plate-shaped conductor having a constant width, a constant thickness, and a predetermined length. The second parallel line 22p2 extends parallel to the signal line 10 (in the longitudinal direction X). The second parallel line 22p2 and the signal line 10 are disposed with a spacing therebetween in the intersection direction Y. Among ends of the second parallel line 22p2, an end located on the −X side is referred to as a first end (one end), and an end located on the +X side is referred to as a second end (the other end). Among side edges of the second parallel line 22p2, a side edge located on the −Y side is referred to as a first side edge (one side edge), and a side edge located on the +Y side is referred to as a second side edge (the other side edge).

The second parallel line 22p2 is provided on an opposite side of the first parallel line 21p1 with respect to the signal line 10. Stated another way, the second parallel line 22p2 is disposed such that the signal line 10 is located between the first parallel line 21p1 and the second parallel line 22p2 in the intersection direction Y.

The upper pad 22d1 is a rectangular flat plate conductor that is connected to the first end (−X side) of the second parallel line 22p2. Long sides of the upper pad 22d1 extend in the intersection direction Y, and short sides of the upper pad 22d1 extend in the longitudinal direction X. Among the short sides of the upper pad 22d1, a short side located on the −Y side is referred to as a first short side (one short side), and a short side located on the +Y side is referred to as a second short side (the other short side). The first short side (−Y side) of the upper pad 22d1 is located at substantially the same position as the first side edge (−Y side) of the second parallel line 22p2 in the intersection direction Y. Further, the second short side (+Y side) of the upper pad 22d1 is located on the rear side (+Y side) with respect to the second side edge (+Y side) of the second parallel line 22p2, That is, a dimension of the upper pad 22d1 in the intersection direction Y is larger than a width (dimension in the intersection direction Y) of the second parallel line 22p2.

The upper pad 22d2 (second upper pad) is a rectangular flat plate conductor that is connected to the second end (+X side) of the second parallel line 22p2. Long sides of the upper pad 22d2 extend in the intersection direction Y, and short sides of the upper pad 22d2 extend in the longitudinal direction X. Among the short sides of the upper pad 22d2, a short side located on the −Y side is referred to as a first short side (one short side). and a short side located on the +Y side is referred to as a second short side (the other short side). The first short side (−Y side) of the upper pad 22d2 is located at substantially the same position as the first side edge (−Y side) of the second parallel line 22p2 in the intersection direction Y. Further, the second short side (+Y side) of the upper pad 22d2 is located on the rear side (+Y side) with respect to the second side edge (+Y side) of the second parallel line 22p2. That is, a dimension of the upper pad 22d2 in the intersection direction Y is larger than the width (dimension in the intersection direction Y) of the second parallel line 22p2.

The third line 23 is formed in a different layer from a layer in which the signal line 10, the first line 21, the second line 22, the upper pad 24, and the upper pad 25 are formed, and from a layer in which the first ground conductor 31 and the second ground conductor 32 are formed. For example, the third line 23 is formed in a layer in which second intermediate pads 71b, 72b, 73b, and 74b (details will be described later) shown in FIGS. 2 and 3 are formed. The third line 23 may be formed in a layer in which third intermediate pads 71c, 72c, 73c, and 74c (details will be described later) shown in FIGS. 2 and 3 are formed.

The third line 23 is formed in such a layer in order to make a thickness (cross-sectional area) of the third line 23 smaller than thicknesses (cross-sectional areas) of the signal line 10, the first line 21, and the second line 22. In general, in a semiconductor having a multilayer structure, a wiring is formed to have a smaller thickness as the wiring goes to an inner layer from a surface. Therefore, in the present embodiment, the third line 23 is formed in a lower layer (inner layer) than the layer in which the signal line 10, the first line 21, the second line 22, the upper pad 24, and the upper pad 25 are formed, so that the thickness (cross-sectional area) of the third line 23 is set to be smaller than the thicknesses (cross-sectional areas) of the signal line 10, the first line 21, and the second line 22.

Although details will be described later, the reason why the thickness of the third line 23 is set to be smaller than the thicknesses of the signal line 10, the first line 21, and the second line 22 is to increase the intensity of the magnetic field generated by the current (third return current) flowing through the third line 23 and to increase the resistance of the third line 23. It is desirable to set the thickness of the third line 23 such that the cross-sectional area of the third line 23 is less than ⅕ of the cross-sectional areas of the signal line 10, the first line 21, and the second line 22.

The first intersecting line 23c1 is a strip-shaped conductor that is electrically connected to the first end (−X side) of the second parallel line 22p2. A bent portion CR1 is formed in the first intersecting line 23c1, and a side of the first intersecting line 23c1 close to the second parallel line 22p2 (for example, a portion of the first intersecting line 23c1 on the second parallel line 22p2 side with respect to a position of a midpoint of the first intersecting line 23c1 in the intersection direction Y) has a crank shape. In plan view, the first intersecting line 23c1 extends away from the signal line 10 in the intersection direction Y from the first end (−X side) of the second parallel line 22p2, is bent to the right side (+X side) in the bent portion CR1, and then extends away from the signal line 10 in the intersection direction Y again. Among ends of the first intersecting line 23c1, an end located on the +Y side is referred to as a first end (one end) or a rear end, and an end located on the −Y side is referred to as a second end (the other end) or a front end.

The third parallel line 23p3 is a linear strip-shaped conductor connected to the first end (+Y side) of the first intersecting line 23c1. The third parallel line 23p3 is an elongated plate-shaped conductor having a constant width, a constant thickness, and a predetermined length. The third parallel line 23p3 extends parallel to the signal line 10 (in the longitudinal direction X) from the first end (+Y side) of the first intersecting line 23c1. That is, the third parallel line 23p3 of the present embodiment extends toward the right side (+X side) from the first end (+Y side) of the first intersecting line 23c1. The length of the third parallel line 23p3 is shorter than the length of the second parallel line 22p2. Among ends of the third parallel line 23p3, an end located on the +X side is referred to as a first end (one end), and an end located on the −X side is referred to as a second end (the other end).

The third parallel line 23p3 is provided at a position farther from the signal line 10 than the second parallel line 22p2 on the first side (+Y side) of the signal line 10. Stated another way, the third parallel line 23p3 is disposed such that the second parallel line 22p2 is located between the signal line 10 and the third parallel line 23p3 in the intersection direction Y.

As shown in FIG. 1, in the intersection direction Y, a distance D1 between a center line of the second parallel line 22p2 and a center line of the third parallel line 23p3 is larger than a distance D2 between the center line of the second parallel line 22p2 and an outer edge of the first ground conductor 31 (described later) on the rear side (outer edge on the third parallel line 23p3 side).

The bent line 23b is a strip-shaped conductor that is connected to the first end (+X side) of the third parallel line 23p3 and in which a bent portion CR is formed. The bent line 23b is formed of a first partial line 23b1 and a second partial line 23b2. The first partial line 23b1 extends toward the signal line 10 in the intersection direction Y from the first end (+X side) of the third parallel line 23p3. Among ends of the first partial line 23b1, an end located on the −Y side is referred to as a first end (one end), and an end located on the +Y side is referred to as a second end (the other end). The second partial line 23b2 extends parallel to the signal line 10 (in the longitudinal direction X) from the first end (−Y side) of the first partial line 23b1. Among ends of the second partial line 23b2, an end located on the +X side is referred to as a first end (one end), and an end located on the −X side is referred to as a second end (the other end). The partial lines 23b1 and 23b2 forming the bent line 23b are elongated plate-shaped conductors having a constant width, a constant thickness, and a predetermined length. The length of the first partial line 23b1 is shorter than the length of the first intersecting line 23c1. A plurality of bent portions CR may be formed in the bent line 23b. In the present embodiment, the first end of the second partial line 23b2 is a first end (one end) of the bent line 23b, and the second end of the first partial line 23b1 is a second end (the other end) of the bent line 23b.

The second intersecting line 23c2 is a strip-shaped conductor that is connected to the first end (+X side) of the second partial line 23b2 constituting the bent line 23b. A bent portion CR2 is formed in the second intersecting line 23c2, and a side of the second intersecting line 23c2 close to the second parallel line 22p2 (for example, a portion of the second intersecting line 23c2 on the second parallel line 22p2 side with respect to a position of a midpoint of the second intersecting line 23c2 in the intersection direction Y) has a crank shape. In plan view, the second intersecting line 23c2 extends toward the signal line 10 in the intersection direction Y from the first end (+X side) of the second partial line 23b2 constituting the bent line 23b, is bent to the right side (+X side) in the bent portion CR2, and then extends toward the signal line 10 in the intersection direction Y again. Among ends of the second intersecting line 23c2, an end located on the −Y side is referred to as a first end (one end), and an end located on the +Y side is referred to as a second end (the other end). The first end of the second intersecting line 23c2 is a first end (one end) of the third line 23.

The first end (−Y side) of the second intersecting line 23c2 of the present embodiment is located at substantially the same position as the first short sides (−Y side) of the upper pads 22d1 and 22d2 and the first side edge (−Y side) of the second parallel line 22p2 in the intersection direction Y. In addition, the upper pad 22d2 and the second intersecting line 23c2 are disposed with a spacing therebetween in the longitudinal direction X.

In addition, the first end (−Y side) of the second intersecting line 23c2 of the present embodiment is electrically connected to the second ground conductor 32 (described later) through a conductor (not shown) at all times. Stated another way, the first end of the third line 23 is electrically connected to the second ground conductor 32 through the conductor (not shown) at all times.

The first intersecting line 23c1, the third parallel line 23p3, the bent line 23b, and the second intersecting line 23c2 constitute a loop line that is convex toward the rear side (+Y side). That is, the third line 23 is a loop line that is convex toward the rear side (+Y side).

The upper pad 24 is a rectangular flat plate conductor similar to the upper pads 21d1 and 21d2 forming a part of the first line 21. Long sides of the upper pad 24 extend in the intersection direction Y, and short sides of the upper pad 24 extend in the longitudinal direction X. Among the short sides of the upper pad 24, a short side located on the +Y side is referred to as a first short side (one short side), and a short side located on the −Y side is referred to as a second short side (the other short side). The first short side (+Y side) of the upper pad 24 is located at substantially the same position as the first side edge (+Y side) of the first parallel line 21p1 in the intersection direction Y. Further, the second short side (−Y side) of the upper pad 24 is located on the front side (−Y side) with respect to the second side edge (−Y side) of the first parallel line 21p1. That is, a dimension of the upper pad 24 in the intersection direction Y is larger than the width (dimension in the intersection direction Y) of the first parallel line 21p1, similarly to the upper pads 21d1 and 21d2 forming a part of the first line 21. In addition, the upper pad 24 is electrically connected to the second ground conductor 32 through a conductor (not shown) at all times, as in the first end (−Y side) of the second intersecting line 23c2.

The upper pad 25 is a rectangular flat plate conductor similar to the upper pads 22d1 and 22d2 forming a part of the second line 22. Long sides of the upper pad 25 extend in the intersection direction Y, and short sides of the upper pad 25 extend in the longitudinal direction X. Among the short sides of the upper pad 25, a short side located on the −Y side is referred to as a first short side (one short side), and a short side located on the +Y side is referred to as a second short side (the other short side). The first short side (−Y side) of the upper pad 25 is located at substantially the same position as the first side edge (−Y side) of the second parallel line 22p2 in the intersection direction Y. Further, the second short side (+Y side) of the upper pad 25 is located on the rear side (+Y side) with respect to the second side edge (+Y side) of the second parallel line 22p2. That is, a dimension of the upper pad 25 in the intersection direction Y is larger than the width (dimension in the intersection direction Y) of the second parallel line 22p2, similarly to the upper pads 22d1 and 22d2 forming a part of the second line 22. In addition, the upper pad 25 is electrically connected to the second ground conductor 32 through a conductor (not shown) at all times, as in the first end (−Y side) of the second intersecting line 23c2.

The first ground conductor 31 is a plate-shaped conductor provided on the input end side (−X side) of the signal line 10. The first ground conductor 31 is electrically grounded. The first ground conductor 31 has a rectangular shape in which long sides extend in the intersection direction Y and short sides extend in the longitudinal direction X. In addition, the first ground conductor 31 overlaps the upper pads 21d1 and 22d1 and the end portion of the first intersecting line 23c1 on the front side (−Y side), in the up-down direction Z. As shown in FIG. 2, the first ground conductor 31 is located below (on the −Z side of) the signal line 10, the first line 21 (upper pad 21d1), the second line 22 (upper pad 22d1), and the third line 23 (first intersecting line 23c1). Among ends of the first ground conductor 31, an end located on the +Y side is referred to as a first end (one end), and an end located on the −Y side is referred to as a second end (the other end).

The second ground conductor 32 is a plate-shaped conductor provided on the output end side (+X side) of the signal line 10. The second ground conductor 32 is electrically grounded. Although not shown in detail, the second ground conductor 32 is located below (on the −Z side of) the signal line 10, the first line 21, the second line 22, the third line 23, and the upper pads 24 and 25. The second ground conductor 32 has a rectangular shape in which long sides extend in the intersection direction Y and short sides extend in the longitudinal direction X. Among the short sides of the second ground conductor 32, a short side located on the +Y side is referred to as a first short side (one short side), and a short side located on the −Y side is referred to as a second short side (the other short side).

As shown in FIG. 2, the first connection pad P1 includes the upper pad 21d1 described above, a first intermediate pad 71a, the second intermediate pad 71b, the third intermediate pad 71c, and the first ground conductor 31. The upper pad 21d1, the first intermediate pad 71a, the second intermediate pad 71b, the third intermediate pad 71c, and the first ground conductor 31 overlap each other in plan view. In addition, the upper pad 21d1, the first intermediate pad 71a, the second intermediate pad 71b, the third intermediate pad 71c, and the first ground conductor 31 are arranged in this order from the upper side (+Z side) to the lower side (−Z side), and are disposed with spacings therebetween in the up-down direction Z.

As shown in FIG. 2, the upper pad 21d1 and the first intermediate pad 71a are electrically and mechanically connected to each other through the plurality of connection conductors 50. In addition, the first intermediate pad 71a and the second intermediate pad 71b are electrically and mechanically connected to each other through the plurality of connection conductors 50. In addition, the second intermediate pad 71b and the third intermediate pad 71c are electrically and mechanically connected to each other through the plurality of connection conductors 50. In addition, the third intermediate pad 71c and the first ground conductor 31 are electrically and mechanically connected to each other through the plurality of connection conductors 50. As a result, the first connection pad P1 electrically connects the first end (−X side) of the first parallel line 21p1 and the first ground conductor 31 at all times.

In the present specification, the “connection conductor 50” is a conductor extending in the up-down direction Z, and is a member that electrically and mechanically connects a member connected to an upper end of the connection conductor 50 and a member connected to a lower end of the connection conductor 50. The connection conductor 50 is, for example, a via that penetrates an insulating layer (not shown) in the up-down direction Z.

As shown in FIG. 2, the second connection pad P2 includes the upper pad 22d1, a first intermediate pad 72a, the second intermediate pad 72b, the third intermediate pad 72c, and the first ground conductor 31, The upper pad 22d1, the first intermediate pad 72a, the second intermediate pad 72b, the third intermediate pad 72c, and the first ground conductor 31 overlap each other in plan view. In addition, the upper pad 22d1, the first intermediate pad 72a, the second intermediate pad 72b, the third intermediate pad 72c, and the first ground conductor 31 are arranged in this order from the upper side (+Z side) to the lower side (−Z side), and are disposed with spacings therebetween in the up-down direction Z.

As shown in FIG. 2, the upper pad 22d1 and the first intermediate pad 72a are electrically and mechanically connected to each other through the plurality of connection conductors 50. In addition, the first intermediate pad 72a and the second intermediate pad 72b are electrically and mechanically connected to each other through the plurality of connection conductors 50. In addition, the second intermediate pad 72b and the third intermediate pad 72c are electrically and mechanically connected to each other through the plurality of connection conductors 50. In addition, the third intermediate pad 72c and the first ground conductor 31 are electrically and mechanically connected to each other through the plurality of connection conductors 50. As a result, the second connection pad P2 electrically connects the first end (−X side) of the second parallel line 22p2 and the first ground conductor 31 at all times.

Here, as shown in FIG. 2, the end portion of the first intersecting line 23c1 on the front side (−Y side) is connected to the second intermediate pad 72b included in the second connection pad P2. As a result, the second connection pad P2 electrically connects the third line 23 and the first ground conductor 31 at all times. The end portion of the first intersecting line 23c1 on the front side (−Y side) may be connected to the third intermediate pad 72c included in the second connection pad P2.

As shown in FIG. 3, the third connection pad P3 includes the upper pad 21d2 described above, a first intermediate pad 73a, the second intermediate pad 73b, the third intermediate pad 73c, and a lower pad 33a. The upper pad 21d2, the first intermediate pad 73a, the second intermediate pad 73b, the third intermediate pad 73c, and the lower pad 33a overlap each other in plan view. In addition, the upper pad 21d2, the first intermediate pad 73a, the second intermediate pad 73b, the third intermediate pad 73c, and the lower pad 33a are arranged in this order from the upper side (+Z side) to the lower side (−Z side), and are disposed with spacings therebetween in the up-down direction Z.

Here, the lower pad 33a (first lower pad) is a rectangular flat plate conductor in which long sides extend in the intersection direction Y and short sides extend in the longitudinal direction X, as shown in FIG. 1. Among the short sides of the lower pad 33a, a short side located on the +Y side is referred to as a first short side (one short side), and a short side located on the −Y side is referred to as a second short side (the other short side). The lower pad 33a is provided separately from the second ground conductor 32. The presence or absence of electrical connection between the lower pad 33a and the second ground conductor 32 is switched depending on a state of the first electronic switch 41 (described later). Accordingly, the presence or absence of the electrical grounding of the lower pad 33a is switched in accordance with the state of the first electronic switch 41.

As shown in FIG. 3, the upper pad 21d2 and the first intermediate pad 73a are electrically and mechanically connected to each other through the plurality of connection conductors 50. In addition, the first intermediate pad 73a and the second intermediate pad 73b are electrically and mechanically connected to each other through the plurality of connection conductors 50. In addition, the second intermediate pad 73b and the third intermediate pad 73c are electrically and mechanically connected to each other through the plurality of connection conductors 50. In addition, the third intermediate pad 73c and the lower pad 33a are electrically and mechanically connected to each other through the plurality of connection conductors 50. As a result, the third connection pad P3 electrically connects the second end (+X side) of the first parallel line 21p1 and the first electronic switch 41 at all times.

As shown in FIG. 3, the fourth connection pad P4 includes the upper pad 22d2 described above, a first intermediate pad 74a, the second intermediate pad 74b, the third intermediate pad 74c, and a lower pad 33b. The upper pad 22d2, the first intermediate pad 74a. the second intermediate pad 74b, the third intermediate pad 74c, and the lower pad 33b overlap each other in plan view. In addition, the upper pad 22d2, the first intermediate pad 74a, the second intermediate pad 74b, the third intermediate pad 74c, and the lower pad 33b are arranged in this order from the upper side (+Z side) to the lower side (−Z side), and are disposed with spacings therebetween in the up-down direction Z.

Here, the lower pad 33b (second lower pad) is a rectangular flat plate conductor in which long sides extend in the intersection direction Y and short sides extend in the longitudinal direction X, as shown in FIG. 1. Among the short sides of the lower pad 33b, a short side located on the +Y side is referred to as a first short side (one short side), and a short side located on the −Y side is referred to as a second short side (the other short side). The lower pad 33b is provided separately from the second ground conductor 32 and the lower pad 33a. The presence or absence of electrical connection between the lower pad 33b and the second ground conductor 32 is switched depending on a state of the second electronic switch 42 (described later). Accordingly, the presence or absence of the electrical grounding of the lower pad 33b is switched in accordance with the state of the second electronic switch 42.

As shown in FIG. 3, the upper pad 22d2 and the first intermediate pad 74a are electrically and mechanically connected to each other through the plurality of connection conductors 50. In addition, the first intermediate pad 74a and the second intermediate pad 74b are electrically and mechanically connected to each other through the plurality of connection conductors 50. In addition, the second intermediate pad 74b and the third intermediate pad 74c are electrically and mechanically connected to each other through the plurality of connection conductors 50. In addition, the third intermediate pad 74c and the lower pad 33b are electrically and mechanically connected to each other through the plurality of connection conductors 50. As a result, the fourth connection pad P4 electrically connects the second end (+X side) of the second parallel line 22p2 and the second electronic switch 42 at all times.

Here, as shown in FIG. 3, a dimension D12 of the lower pad 33a forming a part of the connection pad P3 in the intersection direction Y is larger than a dimension D11 of the upper pad 21d2 forming a part of the connection pad P3 in the intersection direction Y. In addition, a dimension D22 of the lower pad 33b forming a part of the connection pad P4 in the intersection direction Y is larger than a dimension D21 of the upper pad 22d2 forming a part of the connection pad P4 in the intersection direction Y. Although details will be described later, this configuration is due to the increase in the sizes of the first electronic switch 41 and the second electronic switch 42 that are connected to the lower pads 33a and 33b in order to reduce the loss of the high-frequency signal.

As shown in FIG. 2, for example, the capacitor 60 is a parallel flat plate in which an upper electrode is connected to the signal line 10 and a lower electrode is connected to the first ground conductor 31 through the third electronic switch 43. The capacitor 60 has a capacitance Ca corresponding to the facing area of the parallel flat plate. That is, the capacitance Ca is a circuit constant provided between the signal line 10 and the first ground conductor 31. However, the capacitor 60 may be a comb-tooth type capacitor.

As shown in FIG. 1, the first electronic switch 41 is a transistor that openably and closably connects the lower pad 33a of the third connection pad P3 and the second ground conductor 32. As shown in FIG. 1, the first electronic switch 41 of the present embodiment is, for example, a MOS type FET, in which a drain terminal is connected to the lower pad 33a of the third connection pad P3, a source terminal is connected to the second ground conductor 32, and a gate terminal is connected to the switch control unit 80.

The first electronic switch 41 switches the conduction state between the drain terminal and the source terminal between the open state and the closed state based on the gate signal input to the gate terminal from the switch control unit 80. That is, the switch control unit 80 causes the first electronic switch 41 to switch between the conduction state and the cut-off state between the second end (+X side) of the first parallel line 21p1 and the second ground conductor 32.

As shown in FIG. 1, the second electronic switch 42 is a transistor that openably and closably connects the lower pad 33b of the fourth connection pad P4 and the second ground conductor 32. As shown in FIG. 1, the second electronic switch 42 of the present embodiment is, for example, a MOS type FET, in which a drain terminal is connected to the lower pad 33b of the fourth connection pad P4, a source terminal is connected to the second ground conductor 32, and a gate terminal is connected to the switch control unit 80.

The second electronic switch 42 switches the conduction state between the drain terminal and the source terminal between the open state and the closed state based on the gate signal input to the gate terminal from the switch control unit 80. That is, the switch control unit 80 causes the second electronic switch 42 to switch between the conduction state and the cut-off state between the second end (+X side) of the second parallel line 22p2 and the second ground conductor 32.

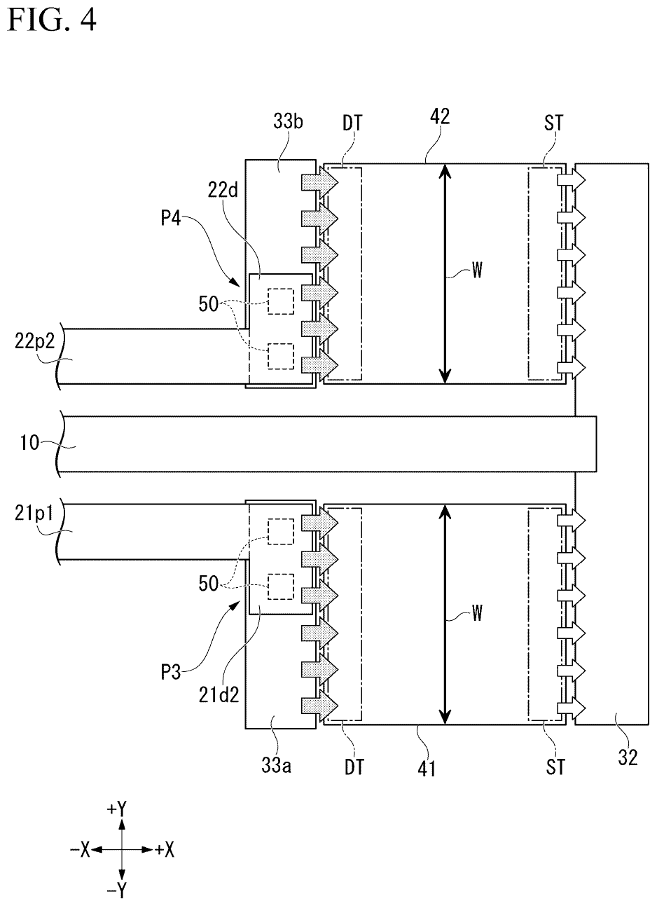

FIG. 4 is a plan view showing a connection relationship between the connection pads and the first and second electronic switches in the digital phase-shift circuit according to the first embodiment of the present invention. As shown in FIG. 4, the first electronic switch 41 and the second electronic switch 42 are, for example, MOS type FETs having a rectangular shape in plan view, and each includes the drain terminal DT and the source terminal ST. In FIG. 4, the gate terminals are not shown.

As described above, the first electronic switch 41 and the second electronic switch 42 have a large size (specifically, a gate width W) in order to reduce the loss of the high-frequency signal. In a case where the sizes of the first electronic switch 41 and the second electronic switch 42 are increased, the lengths of the drain terminal DT and the source terminal ST in the intersection direction Y are also increased as shown in FIG. 4.

In a case where the dimension D12 (see FIG. 3) of the lower pad 33a in the intersection direction Y is about the same as the dimension D11 of the upper pad 21d2 in the intersection direction Y, only a part of the drain terminal DT of the first electronic switch 41 is connected to the lower pad 33a. Similarly, in a case where the dimension D22 (see FIG. 3) of the lower pad 33b in the intersection direction Y is about the same as the dimension D21 of the upper pad 22d2 in the intersection direction Y, only a part of the drain terminal DT of the second electronic switch 42 is connected to the lower pad 33b.

In the present embodiment, the dimension D12 of the lower pad 33a in the intersection direction Y is lengthened according to the length of the drain terminal DT of the first electronic switch 41 in the intersection direction Y. That is, the dimension D12 of the lower pad 33a in the intersection direction Y is set to be larger than the dimension D11 of the upper pad 21d2 in the intersection direction Y. As a result, the entire drain terminal DT of the first electronic switch 41 is connected to the lower pad 33a.

Similarly, the dimension D22 of the lower pad 33b in the intersection direction Y is lengthened according to the length of the drain terminal DT of the second electronic switch 42 in the intersection direction Y. That is, the dimension D22 of the lower pad 33b in the intersection direction Y is set to be larger than the dimension D21 of the upper pad 22d2 in the intersection direction Y. As a result, the entire drain terminal DT of the second electronic switch 42 is connected to the lower pad 33b.

The second short side (−Y side) of the second ground conductor 32 is located at substantially the same position as the second short side (−Y side) of the lower pad 33a in the intersection direction Y. That is, the second ground conductor 32 extends from the first short side (+Y side) of the lower pad 33b to the second short side (−Y side) of the lower pad 33a in the intersection direction Y. Therefore, as shown in FIG. 4, the entire source terminals ST of the first electronic switch 41 and the second electronic switch 42 are also connected to the second ground conductor 32.

As shown in FIG. 2, the third electronic switch 43 is a transistor that openably and closably connects the lower electrode of the capacitor 60 and the first ground conductor 31. The third electronic switch 43 is, for example, a MOS type FET, in which a drain terminal is connected to the lower electrode of the capacitor 60, a source terminal is connected to the first ground conductor 31, and a gate terminal is connected to the switch control unit 80.

Here, as shown in FIG. 2, the third electronic switch 43 is disposed at a position away from the signal line 10 toward the rear side (+Y side). In addition, the first end (+Y side) of the first ground conductor 31 extends away from the signal line 10 in the intersection direction Y and is connected to the third electronic switch 43. The reason for such a disposition is that there is a design rule constraint for the connection of the lower electrode of the capacitor 60 in a specific semiconductor manufacturing process.

Specifically, in a specific semiconductor manufacturing apparatus, there is a restriction that the lower electrode of the capacitor 60 is once connected to an upper wiring layer (for example, a layer in which the signal line 10 is formed) through a connection wiring and a via, and is connected to a lower wiring layer through a via from the upper wiring layer. Note that in FIG. 2, a connection path between the lower electrode of the capacitor 60 and the third electronic switch 43 is shown in a simplified manner. Due to this restriction, the third electronic switch 43 cannot be disposed in the vicinity of the position (for example, the input end side (−X side) of the signal line 10 shown in FIG. 1) at which the capacitor 60 is formed, and needs to be disposed at a position away from the signal line 10 toward the rear side (+Y side). The first ground conductor 31 is connected to the source terminal of the third electronic switch 43 disposed at such a position, and thus extends away from the signal line 10 in the intersection direction Y.

The third electronic switch 43 switches the conduction state between the drain terminal and the source terminal between the open state and the closed state based on the gate signal input to the gate terminal from the switch control unit 80. That is, the switch control unit 80 causes the third electronic switch 43 to switch between the conduction state and the cut-off state between the lower electrode of the capacitor 60 and the first ground conductor 31.

Here, the sizes (gate widths) of the first electronic switch 41 and the second electronic switch 42 are set to, for example, at least twice the size (gate width) of the third electronic switch 43. It is preferable that the sizes (gate widths) of the first electronic switch 41 and the second electronic switch 42 be at least 5 times the size (gate width) of the third electronic switch 43.

Although details will be described later, in the present embodiment, the loss of the high-frequency signal in the high-delay mode can be significantly reduced. Since it is desirable that a difference between the loss of the high-frequency signal in the high-delay mode and the loss of the high-frequency signal in the low-delay mode be as small as possible, when the loss of the high-frequency signal in the high-delay mode is reduced, it is also necessary to reduce the loss of the high-frequency signal in the low-delay mode. Therefore, the sizes of the first electronic switch 41 and the second electronic switch 42 are set to be larger than the size of the third electronic switch 43.

In order to reduce a difference between the loss of the high-frequency signal in the high-delay mode and the loss of the high-frequency signal in the low-delay mode, it is necessary to set the sizes of the first electronic switch 41 and the second electronic switch 42 to be at least twice the size of the third electronic switch 43. In addition, in a case where the sizes of the first electronic switch 41 and the second electronic switch 42 are set to be at least 5 times the size of the third electronic switch 43, the loss of the high-frequency signal in the high-delay mode and the loss of the high-frequency signal in the low-delay mode can be set to be about the same.

As shown in FIG. 2, the fourth electronic switch 44 is a transistor that openably and closably connects the input end side (−X side) of the signal line 10 and the first ground conductor 31. Similar to the first electronic switch 41, the second electronic switch 42, and the third electronic switch 43 described above, the fourth electronic switch 44 is an MOS type FET, in which a drain terminal is connected to the input end side (−X side) of the signal line 10, a source terminal is connected to the first ground conductor 31, and a gate terminal is connected to the switch control unit 80. In addition, the fourth electronic switch 44 may be provided not between the input end side (−X side) of the signal line 10 and the first ground conductor 31 but between the output end side (+X side) of the signal line 10 and the second ground conductor 32.

The Fourth electronic switch 44 switches the conduction state between the drain terminal and the source terminal between the open state and the closed state based on the gate signal input to the gate terminal from the switch control unit 80. That is, the switch control unit 80 causes the fourth electronic switch 44 to switch between the conduction state and the cut-off state between the input end side (−X side) of the signal line 10 and the first ground conductor 31.

The switch control unit 80 is a control circuit that controls the first electronic switch 41, the second electronic switch 42, the third electronic switch 43, and the fourth electronic switch 44 described above. The switch control unit 80 includes four output ports, and individually outputs the gate signals from each output port to the gate terminals of the first electronic switch 41, the second electronic switch 42, the third electronic switch 43, and the fourth electronic switch 44. That is, the switch control unit 80 opens or closes the first electronic switch 41, the second electronic switch 42, the third electronic switch 43, and the fourth electronic switch 44 using the gate signal.

Next, the operations of the digital phase-shift circuit B configured as described above will be described.

In the digital phase-shift circuit B according to the present embodiment, the operation mode is switched depending on the conduction states of the first to third electronic switches 41 to 43. That is, the operation mode of the digital phase-shift circuit B includes a low-delay mode in which the switch control unit 80 sets the first electronic switch 41 and the second electronic switch 42 to the closed state, and sets the third electronic switch 43 to the open state, and a high-delay mode in which the switch control unit 80 sets the first electronic switch 41 and the second electronic switch 42 to the open state, and sets the third electronic switch 43 to the closed state.

In the low-delay mode, the switch control unit 80 sets the first electronic switch 41 and the second electronic switch 42 to the closed state, and sets the third electronic switch 43 to the open state. That is, in the low-delay mode, the phase at the output end (right end) of the signal line 10 becomes a first phase θ_{L} smaller than a second phase θ_{H} in the high-delay mode, by a first propagation delay time T_{L} until the high-frequency signal propagates from the input end (left end) to the output end (right end) of the signal line 10. Hereinafter, the low-delay mode will be described in more detail.

By setting the first electronic switch 41 to the closed state, the second end (+X side) of the first parallel line 21p1 is connected to the second ground conductor 32 through the third connection pad P3 (see FIG. 1). On the other hand, the first end (−X side) of the first parallel line 21p1 is connected to the first ground conductor 31 at all times through the first connection pad P1 (see FIGS. 1 and 2). Therefore, the first parallel line 21p1 forms a first current path through which the current can flow between the first end (−X side) and the second end (+X side) thereof by connecting the second end (+X side) of the first parallel line 21p1 to the second ground conductor 32 through the first electronic switch 41.

In addition, by setting the second electronic switch 42 to the closed state, the second end (+X side) of the second parallel line 22p2 is connected to the second ground conductor 32 through the fourth connection pad P4 (see FIG. 1). On the other hand, the first end (−X side) of the second parallel line 22p2 is connected to the first ground conductor 31 at all times through the second connection pad P2 (see FIGS. 1 and 2). Therefore, the second parallel line 22p2 forms a second current path through which the current can flow between the first end (−X side) and the second end (+X side) thereof by connecting the second end (+X side) of the second parallel line 22p2 to the second ground conductor 32 through the second electronic switch 42.

In a state where both ends of the first parallel line 21p1 and the second parallel line 22p2 are connected, when a signal current flows from the input end toward the output end in the signal line 10, a return current is generated in the first parallel line 21p1 and the second parallel line 22p2 due to the propagation of the signal current. The return current flows through the first parallel line 21p1 and the second parallel line 22p2 from the second end (+X side) to the first end (−X side).

That is, in the first parallel line 21p1 forming the first current path, a first return current flows in an opposite direction to the flow direction of the signal current due to the flow of the signal current in the signal line 10. In addition, in the second parallel line 22p2 forming the second current path, a second return current flows in an opposite direction to the flow direction of the signal current, that is, the same direction as the first return current, due to the flow of the signal current in the signal line 10.

Here, both the first return current flowing through the first parallel line 21p1 and the second return current flowing through the second parallel line 22p2 flow in an opposite direction to the flow direction of the signal current. Accordingly, the first return current and the second return current act to reduce the overall inductance of the digital phase-shift circuit B due to electromagnetic coupling (mutual induction) between the signal line 10 and the first parallel line 21p1 and electromagnetic coupling (mutual induction) between the signal line 10 and the second parallel line 22p2. An inductance of the signal line 10 is denoted by Ls_{low}, an inductance of the return path (first parallel line 21p1 and second parallel line 22p2) is denoted by Lg_{low}, and a mutual inductance between the signal line 10 and the return path is denoted by M_{low}. The overall inductance L_{low} of the digital phase-shift circuit B in the low-delay mode is Ls_{low}+Lg_{low}−M_{low}.

Further, the signal line 10 has the capacitance C1 as the parasitic capacitance as described above. In the low delay mode, since the third electronic switch 43 is set to the open state, the capacitor 60 is not connected between the signal line 10 and the first ground conductor 31. That is, the capacitance Ca of the capacitor 60 does not affect the high-frequency signal that propagates through the signal line 10. Accordingly, the first propagation delay time T_{L} proportional to (L_{low}×C1)^{1/2} acts on the high-frequency signal that propagates through the signal line 10.

The high-frequency signal at the output end of the signal line 10 has a phase delayed by the first phase θ_{L} with respect to the high-frequency signal at the input end of the signal line 10 due to the first propagation delay time T_{L}. That is, in the low-delay mode, the overall inductance of the digital phase-shift circuit B is the inductance L_{low} due to the first return current and the second return current, so that the propagation delay time is reduced.

On the other hand, in the high-delay mode, the switch control unit 80 sets the first electronic switch 41 and the second electronic switch 42 to the open state, and sets the third electronic switch 43 to the closed state. In addition, the fourth electronic switch 44 is set to the open state. That is, in the high-delay mode, the phase at the output end (right end) of the signal line 10 becomes the second phase θ_{H} that is larger than the first phase θ_{L} in the low-delay mode due to a second propagation delay time T_{H} until the high-frequency signal propagates from the input end (left end) to the output end (right end) of the signal line 10. Hereinafter, the high-delay mode will be described in more detail.

As described above, in the high-delay mode, the first electronic switch 41 and the second electronic switch 42 are set to the open state. Therefore, the first conductive path described above is not formed in the first parallel line 21p1, and the second conductive path described above is not formed in the second parallel line 22p2. Therefore, the first return current that flows through the first parallel line 21p1 becomes extremely small, and the second return current that flows through the second parallel line 22p2 becomes extremely small.

On the other hand, the end portion of the first intersecting line 23c1, which forms a part of the third line 23, on the front side (−Y side) is connected to the first ground conductor 31 at all times through the second connection pad P2 (see FIG. 2). In addition, the first end (−Y side) of the second intersecting line 23c2 forming a part of the third line 23 is connected to the second ground conductor 32 at all times. Accordingly, in the third line 23, a third current path through which the current can flow is formed in advance between the first end (−Y side) of the second intersecting line 23c2 and the end portion of the first intersecting line 23c1 on the front side (−Y side). Therefore, in the high-delay mode, a third return current flows from the first end (−Y side) of the second intersecting line 23c2 toward the end portion of the first intersecting line 23c1 on the front side (−Y side) through the bent line 23b and the third parallel line 23p3, due to the signal current in the signal line 10.

Here, in the third parallel line 23p3 and the second partial line 23b2 of the bent line 23b which are parallel to the signal line 10, the third return current flows in a direction opposite to the flow direction of the signal current in the signal line 10. In addition, the first partial line 23b1 of the bent line 23b, the third parallel line 23p3, and the first intersecting line 23c1 constitute a loop line that is convex toward the side opposite to the signal line 10 (+Y side). Therefore, the inductance of the return path (a path through which the third return current flows) can be increased compared to a configuration in the related art in which the return path does not constitute a loop line. Moreover, in the present embodiment, the thickness of the third line 23 (thicknesses of the first intersecting line 23c1, the third parallel line 23p3, the bent line 23b, and the second intersecting line 23c2) is smaller than the thicknesses of the signal line 10, the first line 21, and the second line 22.

Accordingly, the overall inductance of the digital phase-shift circuit B can be significantly increased, and a desired phase-shift amount can be ensured even at a low frequency at which the phase-shift amount is small. An inductance of the signal line 10 is denoted by Ls_{high}, an inductance of the return path (the second intersecting line 23c2, the bent line 23b, the third parallel line 23p3, and the first intersecting line 23c1) is denoted by Lg_{high}, and a mutual inductance between the signal line 10 and the return path is denoted by M_{high}. Here, Ls_{high}=Ls_{low}. The overall inductance L_{high} of the digital phase-shift circuit B in the high-delay mode is Ls_{high}+Lg_{high}−M_{high}. Here, it is clear that Lg_{low}<Lg_{high} and M_{low}>M_{high} are satisfied, so that L_{high}>L_{low} is satisfied.

It should be noted that the principle in which the third return current acts to increase the inductance of the return path can be described as follows. That is, the magnetic field generated in a case where the third return current flows through the first partial line 23b1 of the bent line 23b, the magnetic field generated in a case where the third return current flows through the third parallel line 23p3, and the magnetic field generated in a case where the third return current flows through the first intersecting line 23c1 are all directed to the same direction (the +Z direction) in the loop line. Therefore, these magnetic fields strengthen each other. Therefore, it is possible to increase the magnetic field generated by the third return current and to increase the inductance of the return path compared to a configuration in the related art in which the line through which the third return current flows does not constitute a loop line. In addition, the value of the inductance of the return path can be greatly changed by adjusting the height of the loop (that is, the position of the third parallel line 23p3 in the intersection direction Y, and the first intersecting line 23c1 and the first partial line 23b1 of the bent line 23b.

Meanwhile, the signal line 10 has the capacitance C1 as the parasitic capacitance. In addition, in the high-delay mode, since the third electronic switch 43 is set to the closed state, the capacitor 60 is connected between the signal line 10 and the first ground conductor 31. That is, the signal line 10 has a capacitance Cb in which the capacitance Ca of the capacitor 60 and the capacitance C1 (parasitic capacitance) are added up. Therefore, the second propagation delay time T_{H}, which is associated with the increase in the inductance of the transmission system and the total capacitance Cb, acts on the high-frequency signal propagating through the signal line 10.

The high-frequency signal at the output end of the signal line 10 has a phase delayed by the second phase Ou with respect to the high-frequency signal at the input end of the signal line 10 due to the second propagation delay time T_{H}. That is, in the high-delay mode, the propagation delay time is increased by increasing the inductance of the transmission system due to the third return current.

Here, in the high-delay mode, the loss of the signal line 10 may be intentionally increased by setting the electronic switch 44 to the closed state. The loss is applied for making the loss of the high-frequency signal in the high-delay mode the same as the loss of the high-frequency signal in the low-delay mode.

### <Digital Phase Shifter>

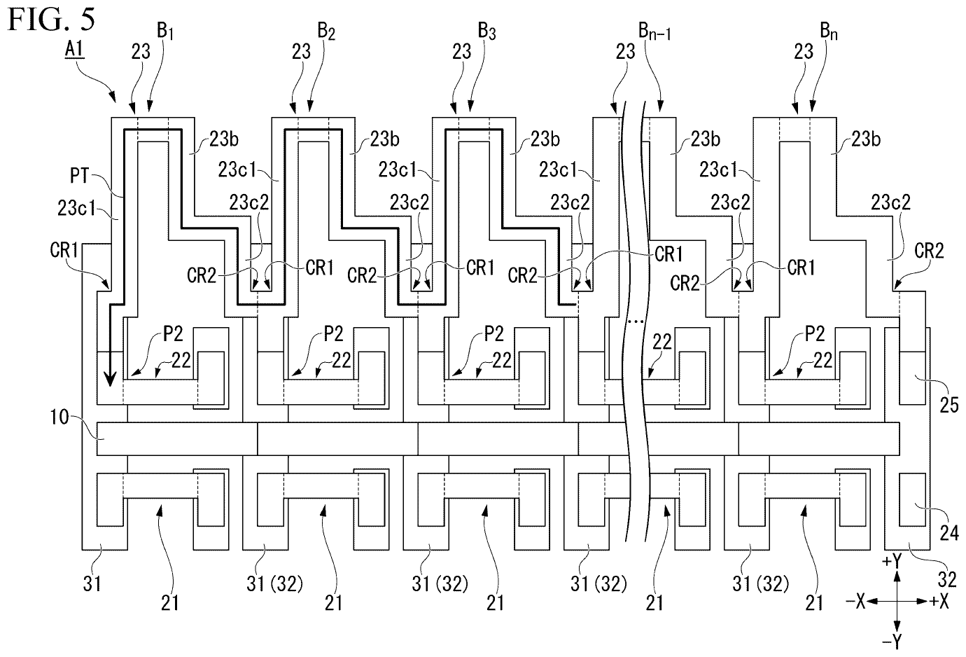

FIG. 5 is a plan view showing a configuration of main parts of a digital phase shifter according to the first embodiment of the present invention. As shown in FIG. 5, in a digital phase shifter A1 of the present embodiment, a plurality of digital phase-shift circuits B₁, B₂, B₃, . . . , Bₙ₋₁, and Bₙ are cascade-connected in the longitudinal direction X. The basic configurations of the digital phase-shift circuits B₁, B₂, B₃, . . . , Bₙ₋₁, and Bₙ are the same as that of the digital phase-shift circuit B described with reference to FIGS. 1 to 4.

The digital phase shifter A1 outputs the high-frequency signal, which is input from the digital phase-shift circuit B₁, from the digital phase-shift circuit Bₙ, or outputs the high-frequency signal, which is input from the digital phase-shift circuit Bₙ, from the digital phase-shift circuit B₁. Hereinafter, as an example, a case will be described in which the high-frequency signal input from the digital phase-shift circuit B₁ is output from the digital phase-shift circuit Bₙ. In FIG. 5, for case of viewing, the first electronic switch 41, the second electronic switch 42, and the switch control unit 80 are not shown.

As shown in FIG. 5, in the digital phase shifter A1, the digital phase-shift circuits B₁, B₂, B₃, . . . , Bₙ₋₁, and Bₙ are cascade-connected in the longitudinal direction X such that the first lines 21 of all the digital phase-shift circuits B₁, B₂, B₃, . . . , Bₙ₋₁, and Bₙ are located on the second side (−Y side) of the signal line 10, and the second lines 22 and the third lines 23 of all the digital phase-shift circuits B₁, B₂, B₃, . . . , Bₙ₋₁, and Bₙ are located on the first side (+Y side) of the signal line 10. That is, the digital phase shifter A1 has a configuration in which the loop lines are disposed only on the first side (+Y side) of the signal line 10. Such a configuration is adopted in order to reduce the size of the digital phase shifter A1.

In the digital phase shifter A1 according to the present embodiment, the digital phase-shift circuits B₁ to Bₙ₋₁ are connected to the digital phase-shift circuits B₂ to Bₙ adjacent to the right side (+X side) such that a part of the digital phase-shift circuits B₁ to Bₙ₋₁ enters the digital phase-shift circuits B₂ to Bₙ. In other words, in the digital phase shifter A1 according to the embodiment, the digital phase-shift circuits B₂ to Bₙ are connected to the digital phase-shift circuits B₁ to Bₙ₋₁ adjacent to the left side (−X side) such that a part of the digital phase-shift circuits B₂ to Bₙ enters the digital phase-shift circuits B₁ to Bₙ₋₁.

More specifically, in a portion in which the digital phase-shift circuits B are adjacent to each other, the first ground conductor 31 and the second ground conductor 32 are used in common, a part of the first intersecting line 23c1 and a part of the second intersecting line 23c2 are used in common, the upper pad 21d1 and the upper pad 24 are used in common, and the upper pad 22d1 and the upper pad 25 are used in common. That is, among the adjacent digital phase-shift circuits B, the first ground conductor 31 of one digital phase-shift circuit B and the second ground conductor 32 of the other digital phase-shift circuit B are used in common, a part of the first intersecting line 23c1 of one digital phase-shift circuit B and a part of the second intersecting line 23c2 of the other digital phase-shift circuit B are used in common, the upper pad 21d1 of one digital phase-shift circuit B and the upper pad 24 of the other digital phase-shift circuit B are used in common, and the upper pad 22d1 of one digital phase-shift circuit B and the upper pad 25 of the other digital phase-shift circuit B are used in common. In the example shown in FIG. 5, for example, the second ground conductor 32 of the digital phase-shift circuit B₁ and the first ground conductor 31 of the digital phase-shift circuit B₂ are used in common, a part of the second intersecting line 23c2 of the digital phase-shift circuit B₁ and a part of the first intersecting line 23c1 of the digital phase-shift circuit B₂ are used in common, the upper pad 24 of the digital phase-shift circuit B₁ and the upper pad 21d1 of the digital phase-shift circuit B₂ are used in common, and the upper pad 25 of the digital phase-shift circuit B₁ and the upper pad 22d1 of the digital phase-shift circuit B₂ are used in common.

Therefore, the first ground conductor 31 of the digital phase-shift circuit B₂ also functions as the second ground conductor 32 of the digital phase-shift circuit B₁. In addition, a part of the first intersecting line 23c1 of the digital phase-shift circuit B₂ also functions as a part of the second intersecting line 23c2 of the digital phase-shift circuit B₁. In addition, the upper pad 21d1 of the digital phase-shift circuit B₂ also functions as the upper pad 24 of the digital phase-shift circuit B₁. In addition, the upper pad 22d1 of the digital phase-shift circuit B₂ also functions as the upper pad 25 of the digital phase-shift circuit B₁.

Here, the bent portion CR1 is formed in the first intersecting line 23c1 forming the third line 23, and a side of the first intersecting line 23c1 close to the second parallel line 22p2 has a crank shape. In addition, the bent portion CR2 is formed in the second intersecting line 23c2 forming the third line 23, and a side of the second intersecting line 23c2 close to the second parallel line 22p2 has a crank shape. Therefore, in the portion in which the digital phase-shift circuits B are adjacent to each other, the first intersecting line 23c1 and the second intersecting line 23c2 that are used in common have a T-shape in plan view extending away from the signal line 10 in the intersection direction Y from the first end (−X side) of the second parallel line 22p2, bent to the right side (+X side) in the bent portion CR1, and bent to the left side (−X side) in the bent portion CR2.

By performing such a connection, it is possible to reduce the decrease in magnetic field caused by interference between the adjacent digital phase-shift circuits B. As a result, the mutual inductance between the adjacent digital phase-shift circuits B can be reduced.

As described above, in the digital phase shifter A1 of the present embodiment, in each of the digital phase-shift circuits B₁ to Bₙ, the line through which the third return current flows constitutes the loop line that is convex toward the side opposite to the signal line 10 (+Y side), and the thickness (cross-sectional area) of the line in which the third return current flows is smaller than the thicknesses (cross-sectional areas) of the signal line 10, the first line 21, and the second line 22. Therefore, the generation efficiency of the magnetic field can be significantly increased compared to the related art. Further, in the digital phase shifter A1 of the present embodiment, as described above, the mutual inductance between the adjacent digital phase-shift circuits B can be reduced. Accordingly, even in a configuration in which the loop lines are disposed only on the first side (+Y side) of the signal line 10, the digital phase shifter A1 of the present embodiment can ensure the required phase-shift amount.

In addition, in the digital phase shifter A1 of the present embodiment, for example, except for the digital phase-shift circuit B₁, in a case where the adjacent digital phase-shift circuits are set to the high-delay mode, the third return current flows through a path that does not pass through the second connection pad P2. For example, in a case where the digital phase-shift circuits B₁ to B₃ are set to the high-delay mode, the third return current flows through a path PT in the drawing without passing through an obstacle having a large loss, such as the second connection pad P2 and the first ground conductor 31 (the second ground conductor 32) of the digital phase-shift circuits B₂ and B₃. Therefore, the digital phase shifter A1 of the present embodiment can significantly reduce the loss of the high-frequency signal in the high-delay mode.

In this way, the digital phase shifter A1 of the present embodiment can significantly reduce the loss of the high-frequency signal in the high-delay mode. As a result, the sizes of the first electronic switch 41 and the second electronic switch 42 disposed on the current paths of the first return current and the second return current in the low-delay mode can be increased. This is because it is desirable that a difference between the loss of the high-frequency signal in the high-delay mode and the loss of the high-frequency signal in the low-delay mode be as small as possible, and thus, when the loss of the high-frequency signal in the high-delay mode is reduced, it is also necessary to reduce the loss of the high-frequency signal in the low-delay mode. In this manner, the digital phase shifter A1 of the present embodiment can reduce the loss of the high-frequency signal as a whole.

As described above, the digital phase shifter A1 of the present embodiment is a phase shifter including the plurality of digital phase-shift circuits B₁ to Bₙ that are cascade-connected. Each of the plurality of digital phase-shift circuits B₁ to Bₙ includes the signal line 10, the first line 21, the second line 22, the third line 23, the first ground conductor 31, the second ground conductor 32, the first electronic switch 41, and the second electronic switch 42. The first line 21 includes the first parallel line 21p1 extending parallel to the signal line 10. The second line 22 includes the second parallel line 22p2 extending parallel to the signal line 10. The third line 23 includes the first intersecting line 23c1 connected to the first end portion of the second parallel line 22p2 and extending away from the signal line 10 in the intersection direction intersecting the longitudinal direction of the signal line 10 from the first end portion of the second parallel line 22p2 in plan view, the third parallel line 23p3 extending parallel to the signal line 10 from the first end portion of the first intersecting line 23c1, and the second intersecting line 23c2 extending toward the signal line 10 in the intersection direction from the first end portion of the third parallel line 23p3.

In addition, each of the plurality of digital phase-shift circuits B₁ to Bₙ includes the first ground conductor 31, the second ground conductor 32, the first electronic switch 41, and the second electronic switch 42. The first ground conductor 31 is electrically connected to the first end portion of the first parallel line 21p1 and the first end portion of the second parallel line 22p2, and the second ground conductor 32 is connected to the first end portion of the third line 23. The first electronic switch 41 is provided between the second end portion of the first parallel line 21p1 and the second ground conductor 32, and the second electronic switch 42 is provided between the second end portion of the second parallel line 22p2 and the second ground conductor 32.

In addition, in each of the plurality of digital phase-shift circuits B₁ to Bₙ, the signal line 10 is located between the first parallel line 21p1 and the second parallel line 22p2. The cross-sectional area of the third line 23 is smaller than the cross-sectional areas of the signal line 10, the first line 21, and the second line 22. In the first intersecting line 23c1 and the second intersecting line 23c2 included in the third line 23, a side of the first intersecting line 23c1 close to the second parallel line 22p2 has a crank shape, and a side of the second intersecting line 23c2 close to the second parallel line 22p2 has a crank shape.

In the digital phase shifter A1 of the present embodiment, in the portion in which the digital phase-shift circuits are adjacent to each other, the first ground conductor 31 and the second ground conductor 32 are used in common. In addition, in the portion in which the digital phase-shift circuits are adjacent to each other, the second intersecting line 23c2 of the third line 23 is connected to the first intersecting line 23c1 of the third line 23 of the adjacent digital phase-shift circuit. With the above-described configuration, it is possible to achieve desired phase-shift characteristics with a small size compared to the related art. In addition, in the present embodiment, a desired phase-shift amount can be ensured even at a low frequency.

### Second Embodiment

### <Digital Phase-Shift Circuit>

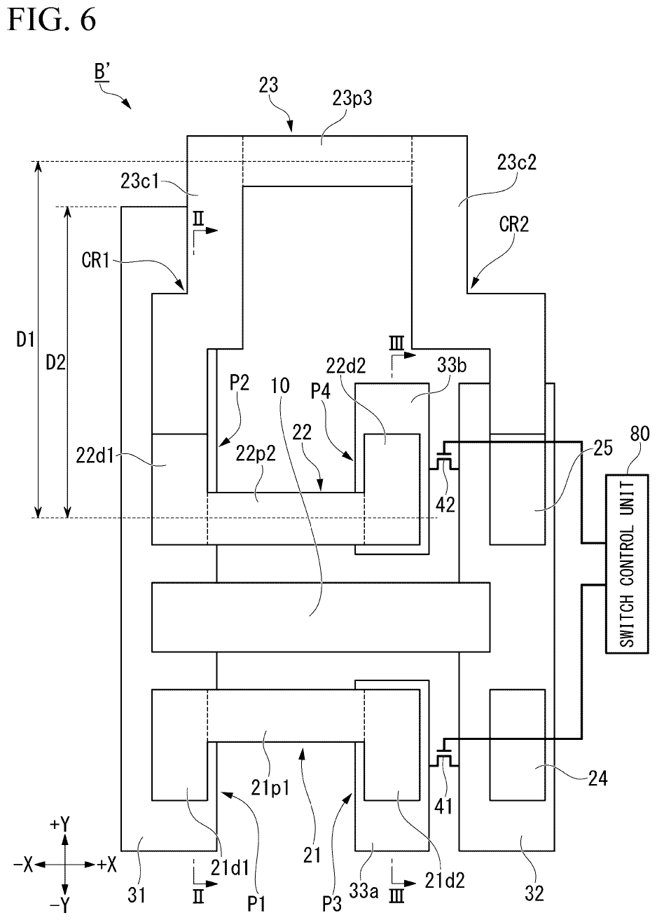

FIG. 6 is a plan view showing a basic configuration of a digital phase-shift circuit according to a second embodiment of the present invention. In FIG. 6, the same components as those shown in FIG. 1 are denoted by the same reference numerals. As shown in FIG. 6, a digital phase-shift circuit B′ according to the present embodiment has substantially the same configuration as the digital phase-shift circuit B shown in FIG. 1, but has a different configuration of the third line 23. Specifically, the third line 23 is formed by the first intersecting line 23c1, the third parallel line 23p3, and the second intersecting line 23c2, in which the bent line 23b shown in FIG. 1 is omitted. The digital phase-shift circuit B′ is compatible with a higher frequency (for example, 39 GHz).

Specifically, in the present embodiment, the length of the first intersecting line 23c1 constituting the third line 23 in the intersection direction Y is shorter than the length of the first intersecting line 23c1 shown in FIG. 1 because the bent line 23b is omitted. Since the bent line 23b is omitted, the third parallel line 23p3 extends to connect the end portion of the first intersecting line 23c1 on the rear side (+Y side) and the end portion of the second intersecting line 23c2 on the rear side (+Y side).

Accordingly, the distance D1 between the center line of the second parallel line 22p2 and the center line of the third parallel line 23p3 of the present embodiment is smaller than the distance D1 between the center line of the second parallel line 22p2 and the center line of the third parallel line 23p3 in the first embodiment. The distance D2 between the center line of the second parallel line 22p2 and the outer edge of the first ground conductor 31 on the rear side (outer edge on the third parallel line 23p3 side) is the same as that of the first embodiment.

### <Digital Phase Shifter>

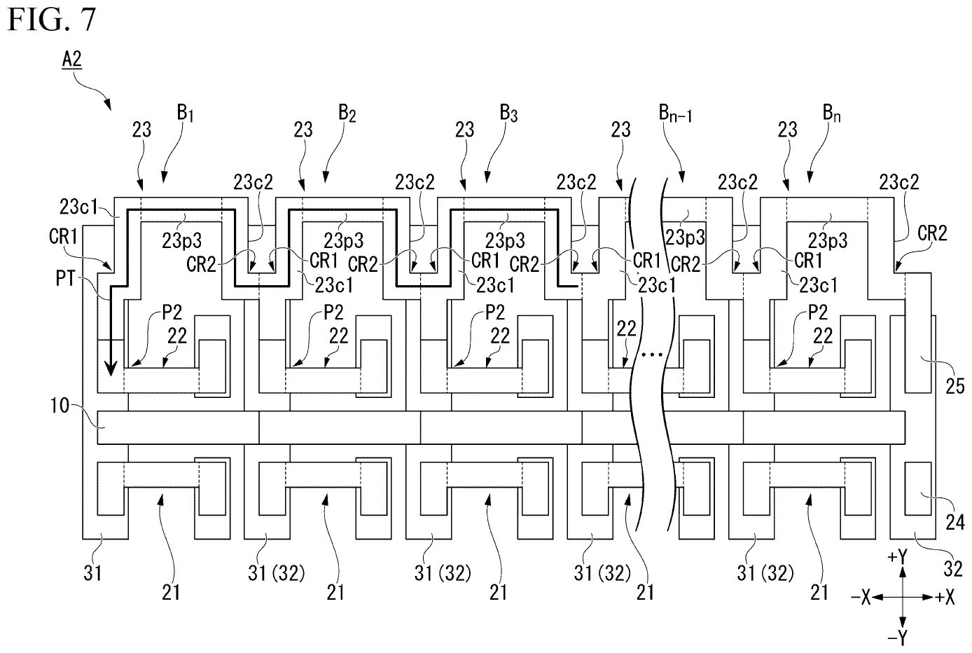

FIG. 7 is a plan view showing a configuration of main parts of a digital phase shifter according to the second embodiment of the present invention. As shown in FIG. 7, in a digital phase shifter A2 of the present embodiment, the plurality of digital phase-shift circuits B₁, B₂, B₃, . . . , Bₙ₋₁, and Bₙ are cascade-connected in the longitudinal direction X. The basic configurations of the digital phase-shift circuits B₁, B₂, B₃, . . . , Bₙ₋₁, and Bₙ are the same as that of the digital phase-shift circuit B′ described with reference to FIG. 6. In FIG. 7, as in FIG. 5, the first electronic switch 41, the second electronic switch 42, and the switch control unit 80 are not shown.

The digital phase shifter A2 shown in FIG. 7 is different from the digital phase shifter A1 shown in FIG. 5 only in the third line 23 provided in each of the digital phase-shift circuits B₁, B₂, B₃, . . . , Bₙ₋₁, and Bₙ, and the configurations of the digital phase shifter A2 other than the third line 23 are the same as those of the digital phase shifter A1 shown in FIG. 5. Therefore, in the digital phase shifter A2 of the present embodiment as well, for example, except for the digital phase-shift circuit B₁, in a case where the adjacent digital phase-shift circuits are set to the high-delay mode, the third return current flows through a path that does not pass through the second connection pad P2. For example, in a case where the digital phase-shift circuits B₁ to B₃ are set to the high-delay mode, the third return current flows through the path PT in the drawing. Therefore, the digital phase shifter A2 of the present embodiment can significantly reduce the loss of the high frequency signal in the high-delay mode, similarly to the digital phase shifter A1 shown in FIG. 5.

As a result, in the digital phase shifter A2 of the present embodiment as well, the sizes of the first electronic switch 41 and the second electronic switch 42 disposed on the current paths of the first return current and the second return current in the low-delay mode can be increased. This is because it is desirable that a difference between the loss of the high-frequency signal in the high-delay mode and the loss of the high-frequency signal in the low-delay mode be as small as possible, and thus, when the loss of the high-frequency signal in the high-delay mode is reduced, it is also necessary to reduce the loss of the high-frequency signal in the low-delay mode. In this manner, the digital phase shifter A2 of the present embodiment can also reduce the loss of the high-frequency signal as a whole.

As described above, the digital phase shifter A2 of the present embodiment is different from the digital phase shifter A1 shown in FIG. 5 only in the third line 23 provided in each of the digital phase-shift circuits B₁, B₂, B₃, . . . , Bₙ₋₁, and Bₙ, and the configurations of the digital phase shifter A2 of the present embodiment other than the third line 23 are the same as those of the digital phase shifter A1 shown in FIG. 5. Therefore, in the digital phase shifter A2 of the present embodiment as well, it is possible to achieve desired phase-shift characteristics with a small size compared to the related art. In addition, in the present embodiment, a desired phase-shift amount can be ensured even in a case where the frequency is high.

### Third Embodiment

### <Digital Phase-Shift Circuit>

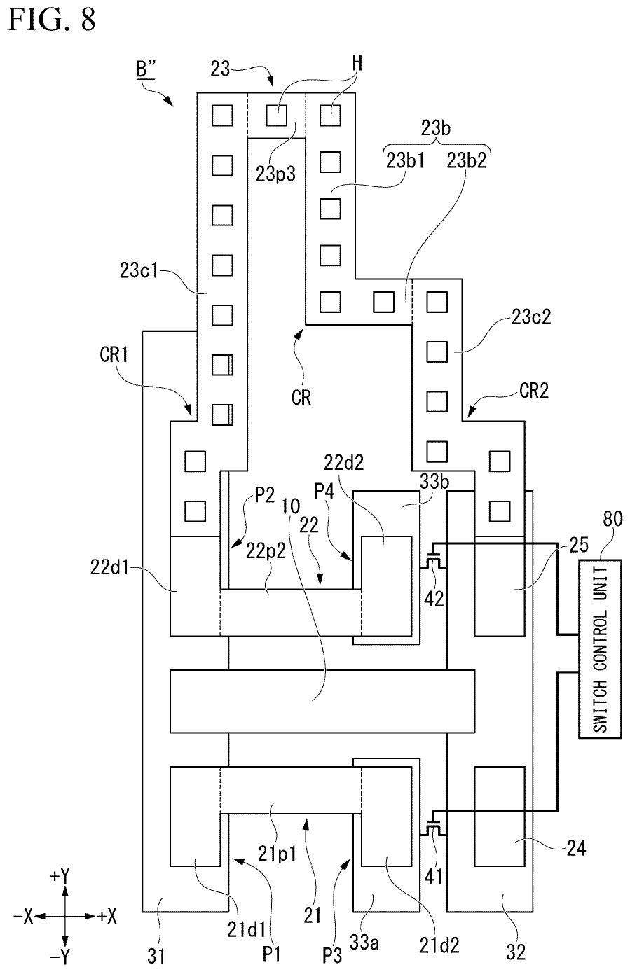

FIG. 8 is a plan view showing a basic configuration of a digital phase-shift circuit according to a third embodiment of the present invention. In FIG. 8, the same components as those shown in FIG. 1 are denoted by the same reference numerals. As shown in FIG. 8, a digital phase-shift circuit B″ according to the present embodiment has substantially the same configuration as the digital phase-shift circuit B shown in FIG. 1, but has a different configuration of the third line 23. Specifically, in the digital phase-shift circuit B″ according to the present embodiment, a plurality of holes H are formed along the third line 23 in the third line 23. The reason for forming the holes H is to increase the resistance of the third line 23.

### <Digital Phase Shifter>

In a digital phase shifter A3 of the present embodiment, the digital phase-shift circuits B″ described with reference to FIG. 8 are cascade-connected in the longitudinal direction X as the digital phase-shift circuits B₁, B₂, B₃, . . . , Bₙ₋₁, and Ba, as in the first and second embodiments. Therefore, the detailed description thereof will be omitted.

As described above, the digital phase-shift circuit B″ and the digital phase shifter A3 of the present embodiment have the same configuration as the digital phase-shift circuit B shown in FIG. 1 and the digital phase shifter A1 shown in FIG. 5 except that the holes H are formed in the third line 23. Therefore, also in the present embodiment, it is possible to achieve desired phase-shift characteristics with a small size compared to the related art, as in the digital phase shifter A1 shown in FIG. 5.

The digital phase-shift circuit B″ according to the present embodiment has a configuration in which the plurality of holes H are formed along the third line 23 in the third line 23 included in the digital phase-shift circuit B shown in FIG. 1. However, a configuration may be adopted in which the plurality of holes H are formed along the third line 23 in the third line 23 included in the digital phase-shift circuit B′ shown in FIG. 6.

In addition, it is not always necessary that all the digital phase-shift circuits B₁, B₂, B₃, . . . , Bₙ₋₁, and Bₙ be the digital phase-shift circuit B″, and at least two digital phase-shift circuits (specific digital phase-shift circuits) among the digital phase-shift circuits B₁, B₂, B₃, . . . , Bₙ₋₁, and Bₙ need only be the digital phase-shift circuits B″. For example, the digital phase-shift circuit B″ may be provided periodically (for example, every one digital phase-shift circuit, every two digital phase-shift circuits, or the like). With this configuration, it is possible to reduce the difference in loss between the low-delay mode and the high-delay mode.

### Fourth Embodiment

### <Digital Phase Shifter>

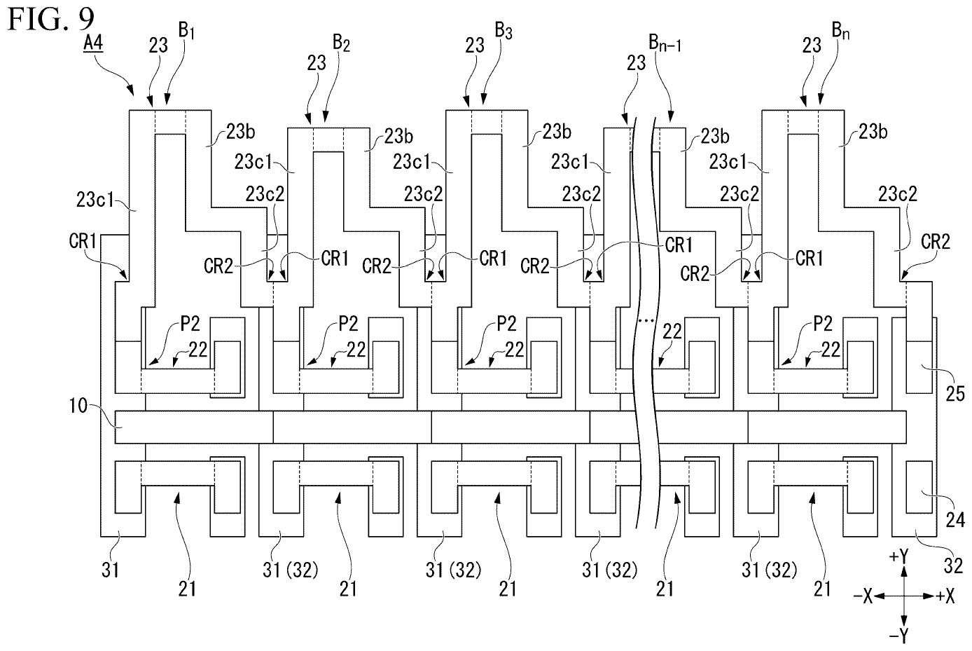

FIG. 9 is a plan view showing a configuration of main parts of a digital phase shifter according to a fourth embodiment of the present invention. As shown in FIG. 9, a digital phase shifter A4 of the present embodiment has substantially the same configuration as the digital phase shifter A1 shown in FIG. 5, but has slightly different configurations of the digital phase-shift circuits B₁, B₂, B₃, . . . , Bₙ₋₁, and Bₙ from the configurations shown in FIG. 5.

Specifically, in the digital phase-shift circuits B₁, B₂, B₃, . . . , Bₙ₋₁, and Bₙ of the present embodiment, the distance D1 (see FIG. 1) between the center line of the second parallel line 22p2 and the center line of the third parallel line 23p3 in the intersection direction Y is different between the adjacent digital phase-shift circuits. For example, the distance D1 in the even-numbered digital phase-shift circuits (digital phase-shift circuits B₂, B₄, B₆, . . . ) is set to be shorter than the distance D1 in the odd-numbered digital phase-shift circuits (digital phase-shift circuits B₁, B₃, B₅, . . . ). Accordingly, the phase-shift amount can be set to be larger in the digital phase shifter A4 of the present embodiment than in the digital phase shifter A1 of the first embodiment.

As described above, the digital phase shifter A4 of the present embodiment has the same configuration as the digital phase shifter A1 shown in FIG. 5 basically, although the distance D1 (see FIG. 1) between the center line of the second parallel line 22p2 and the center line of the third parallel line 23p3 in the intersection direction Y is different between the adjacent digital phase-shift circuits. Therefore, as in the digital phase shifter A1 shown in FIG. 5, it is possible to achieve desired phase-shift characteristics with a small size compared to the related art.

In the digital phase shifter A4 shown in FIG. 9, the distance D1 (see FIG. 1) between the center line of the second parallel line 22p2 and the center line of the third parallel line 23p3 in the intersection direction Y is different between the adjacent digital phase-shift circuits. However, the distance D1 does not always need to be different between the adjacent digital phase-shift circuits. Among the digital phase-shift circuits B₁, B₂, B₃, . . . , Bₙ₋₁, and Bₙ, the distance D1 in at least one digital phase-shift circuit need only be different from the distance D1 in the other digital phase-shift circuits. Further, the distance D1 is not limited to two types, and may be three types or more.

In addition, the digital phase shifter A4 of the present embodiment has a configuration in which the distance D1 varies for the digital phase-shift circuits B₁, B₂, B₃, . . . , Bₙ₋₁, and Bₙ included in the digital phase shifter A1 shown in FIG. 5. However, a configuration may be adopted in which the distance D1 varies for the digital phase-shift circuits B₁, B₂, B₃, . . . , Bₙ₋₁, and Bₙ included in the digital phase shifter A2 shown in FIG. 7.

The digital phase-shift circuit and the digital phase shifter according to the embodiments of the present invention have been described above, but the present invention is not limited to the above described embodiments and can be freely changed within the scope of the present invention. For example, in the above-described embodiments, the thickness of the third line 23 is set to be smaller than the thicknesses of the signal line 10, the first line 21, and the second line 22, so that the cross-sectional area of the third line 23 is set to be smaller than the cross-sectional areas of the signal line 10, the first line 21, and the second line 22. However, the cross-sectional area of the third line 23 may be set to be smaller than the cross-sectional areas of the signal line 10, the first line 21, and the second line 22 by setting the width (the width in plan view) of the third line 23 to be smaller than the widths of the signal line 10, the first line 21, and the second line 22.

In addition, in the above-described embodiments, an example has been described in which the third line 23 is formed in a different layer from the layer in which the signal line 10, the first line 21, the second line 22, and the like are formed and from the layer in which the first ground conductor 31 and the second ground conductor 32 are formed. However, as long as the cross-sectional area of the third line 23 can be set to be smaller than the cross-sectional areas of the signal line 10, the first line 21, and the second line 22, the third line 23 may be formed in the same layer as the layer in which the signal line 10, the first line 21, and the second line 22 are formed.

Further, all the third lines 23 of the digital phase-shift circuits B₁ to Bₙ constituting the digital phase shifters A1 to A4 according to the first to fourth embodiments described above may be formed in the same layer. With this configuration, in a case where the adjacent digital phase-shift circuits are set to the high-delay mode, the return current does not pass through the obstacle, so that the loss can be reduced.

In addition, the third line 23 of at least one digital phase-shift circuit among the digital phase-shift circuits B₁ to Bₙ constituting the digital phase shifters A1 to A4 according to the first to fourth embodiments described above may be formed in a different layer from the third line 23 of the other digital phase-shift circuit. For example, the third line 23 in the digital phase-shift circuit B₁ may be formed on the second intermediate pad 72b (see FIG. 2), and the third lines 23 in the other digital phase-shift circuits B₂ to Bₙ may be formed on the third intermediate pad 72c (see FIG. 2).

### REFERENCE SIGNS LIST

10 Signal line
21 First line
21d2 Upper pad
21p1 First parallel line
22 Second line
22d2 Upper pad
22p2 Second parallel line
23 Third line
23c1 First intersecting line
23c2 Second intersecting line
23p3 Third parallel line
31 First ground conductor
32 Second ground conductor
33a, 33b Lower pad
41 First electronic switch
42 Second electronic switch
43 Third electronic switch
44 Fourth electronic switch
50 Connection conductor
60 Capacitor
A1 to A4 Digital phase shifter
B, B′, B″, B₁ to Bₙ Digital phase-shift circuit
CR1, CR2 Bent portion
D1 Distance
Y Intersection direction

1. A digital phase-shift circuit comprising:
a signal line;
a first line including a first parallel line extending parallel to the signal line;
a second line including a second parallel line extending parallel to the signal line;
a third line including a first intersecting line connected to a first end portion of the second parallel line and extending away from the signal line in an intersection direction intersecting a longitudinal direction of the signal line from the first end portion of the second parallel line in plan view, a third parallel line extending parallel to the signal line from a first end portion of the first intersecting line, and a second intersecting line extending toward the signal line in the intersection direction from a first end portion of the third parallel line;
a first ground conductor electrically connected to a first end portion of the first parallel line and the first end portion of the second parallel line;
a second ground conductor electrically connected to a first end portion of the third line;
a first electronic switch provided between a second end portion of the first parallel line and the second ground conductor; and
a second electronic switch provided between a second end portion of the second parallel line and the second ground conductor,
wherein the signal line is located between the first parallel line and the second parallel line, and
a cross-sectional area of the third line is smaller than cross-sectional areas of the signal line, the first line, and the second line.

2. The digital phase-shift circuit according to claim 1,
wherein the third line has a smaller thickness than the signal line, the first line, and the second line.

3. The digital phase-shift circuit according to claim 1,
wherein the third line is formed in an inner layer than the first line and the second line.

4. The digital phase-shift circuit according to claim 1,
wherein a plurality of holes are formed along the third line in the third line.

5. The digital phase-shift circuit according to claim 1, further comprising:
a capacitor connected to a first end portion of the signal line; and
a third electronic switch provided between the capacitor and the first ground conductor,
wherein a first end portion of the first ground conductor extends away from the signal line in the intersection direction and is connected to the third electronic switch.

6. The digital phase-shift circuit according to claim 5,
wherein the first electronic switch, the second electronic switch, and the third electronic switch are field-effect transistors, and
sizes of the field-effect transistors forming the first electronic switch and the second electronic switch are at least twice a size of the field-effect transistor forming the third electronic switch.

7. The digital phase-shift circuit according to claim 1, further comprising:
a first upper pad provided at the second end portion of the first parallel line; and
a second upper pad provided at the second end portion of the second parallel line,
wherein a maximum value of a dimension of the first upper pad in the intersection direction is larger than a width of the first parallel line, and
a maximum value of a dimension of the second upper pad in the intersection direction is larger than a width of the second parallel line.

8. The digital phase-shift circuit according to claim 7, further comprising:
a first lower pad connected to the first upper pad through a via and to which the first electronic switch is connected; and
a second lower pad connected to the second upper pad through a via and to which the second electronic switch is connected,
wherein a maximum value of a dimension of the first lower pad in the intersection direction is larger than the maximum value of the dimension of the first upper pad in the intersection direction, and
a maximum value of a dimension of the second lower pad in the intersection direction is larger than the maximum value of the dimension of the second upper pad in the intersection direction.

9. The digital phase-shift circuit according to claim 1, further comprising:
a fourth electronic switch provided between a first end portion of the signal line and the first ground conductor.

10. A digital phase shifter comprising:
a plurality of digital phase-shift circuits that are cascade-connected,
wherein each of the plurality of digital phase-shift circuits is the digital phase-shift circuit according to claim 1,
in a portion in which the digital phase-shift circuits are adjacent to each other, the first ground conductor and the second ground conductor are used in common, and
the first intersecting line and the second intersecting line have a crank shape.

11. The digital phase shifter according to claim 10,
wherein at least one digital phase-shift circuit among the plurality of digital phase-shift circuits differs from the other digital phase-shift circuit in a distance between a center line of the second parallel line and a center line of the third parallel line in the intersection direction.

12. A digital phase shifter comprising:
a plurality of digital phase-shift circuits that are cascade-connected,
wherein specific digital phase-shift circuits that are at least two digital phase-shift circuits among the plurality of digital phase-shift circuits are the digital phase-shift circuits according to Claim 4,
in a portion in which the digital phase-shift circuits are adjacent to each other, the first ground conductor and the second ground conductor are used in common, and
the first intersecting line and the second intersecting line have a crank shape.

13. The digital phase shifter according to claim 10,
wherein the third lines of the plurality of digital phase-shift circuits are formed in the same layer.

14. The digital phase shifter according to claim 10,
wherein the third line of at least one digital phase-shift circuit among the plurality of digital phase-shift circuits is formed in a different layer from the third line of the other digital phase-shift circuit.
